(19) United States
(12) Patent Application Publication
(10) Pub. No.: US 2015/0024993 A1
(43) Pub. Date: Jan. 22, 2015

(54) FRAGRANCE DISPENSER SYSTEM FOR USE IN A DRYER II

(71) Applicant: Henkel AG & Co. KGaA, Duesseldorf (DE)

(72) Inventors: Noelle Wrubbel, Duesseldorf (DE); Dirk Weinrich, Grevenbroich (DE); Helga Werner, Rommerskirchen (DE)

(21) Appl. No.: 14/511,470

(22) Filed: Oct. 10, 2014

Related U.S. Application Data
(63) Continuation of application No. PCT/EP2013/056611, filed on Mar. 27, 2013.

(30) Foreign Application Priority Data
Apr. 12, 2012 (DE) 10 2012 205 994.6

(51) Int. Cl. C11D 3/50; C11D 17/04

(52) U.S. Cl. CPC C11D 3/507; C11D 17/047
USPC 512/4

(57) ABSTRACT

The invention relates to a scent release system for repeated use in a dryer, which system comprises a perfumed composition which is located in a release device provided with perforations in the wall. The release device comprises on the external surface an indentation which is at least in part filled with a wax.

### FIELD OF THE INVENTION

The present invention generally relates to a system composed of perfumed composition and release device for use in a dryer for perfuming textiles.

### BACKGROUND OF THE INVENTION

In addition to the removal of stains, soiling or unpleasant odors, it is also important to many consumers for the washed textiles to have a pleasant scent after washing and/or drying. To this end, the textiles are often treated with a rinse conditioner in a subsequent rinsing process after the actual washing and cleaning process.

Most commercially available rinse conditioners are aqueous formulations which contain a cationic textile-softening compound which comprises one or two long-chain alkyl groups in a single molecule as the main active component. Widely used cationic textile softening compounds comprise “esterquats”, for example.

In many cases, for example with towels or functional textiles, using a rinse conditioner is undesirable or even inappropriate. For instance, using conventional rinse conditioners with esterquats may for example impair the breathability of breathable functional textiles. Many consumers do not use any rinse conditioners for towels since the esterquats present therein reduce the absorbency and water absorption capacity of the towels. Consumers would, however, like to impart a pleasant scent to these articles too.

In addition, an ever increasing number of consumers use a tumble dryer to dry textiles. Due to the elevated temperatures associated with drying in a tumble dryer, a major part of the scent imparted during washing of the textiles is often lost.

EP 2414500 A1 therefore discloses a system for use in a tumble dryer which imparts a pleasant scent to the textiles treated in the tumble dryer.

However, there is an additional need to improve the functionality of such systems. It would for example be desirable for systems which are used repeatedly in a tumble dryer to have a means of displaying the end of the service life of the system, i.e. an “end-of-life” indicator.

The problem addressed by the invention is therefore that of further improving the functionality of systems for use in a tumble dryer.

This problem is solved by a system composed of perfumed composition and release device for repeated use in a dryer, wherein the perfumed composition comprises a particulate carrier and a perfume, and the release device comprises in the interior of the device a cavity, formed by one or more walls, for accommodating the perfumed composition and perforations in the wall(s) and wherein the release device comprises an indentation on the outer surface which is filled at least in part with a wax.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A system composed of perfumed composition and release device for repeated use in a dryer, wherein the perfumed composition comprises a particulate carrier and a perfume, and the release device comprises in the interior of the device a cavity, formed by one or more walls, for accommodating the perfumed composition and perforations in the wall(s), characterized in that the release device comprises on the external surface an indentation which is at least in part filled with a wax.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It has surprisingly been found that a wax in an indentation on the outer surface of the release device is released to the treated textiles over a plurality of use cycles and may thus serve as an indicator of the end of the service life of the system. In addition, the wax may impart an advantageous effect to textiles treated therewith, such as for example a textile softening effect, an anti-static effect or an anti-crease effect.

It is preferred for the water-soluble carrier to contain a polymeric material. The polymeric material of the particulate carrier is more preferably selected from the group consisting of ethylene/vinyl acetate copolymers, polyethylenes, polypropylenes, polyethylene/polypropylene copolymers, polyether/polyamide block copolymers, styrene/butadiene (block) copolymers, styrene/isoprene (block) copolymers, styrene/ethylene/butylene copolymers, acrylonitrile/butadiene/styrene copolymers, acrylonitrile/butadiene copolymers, polyetheresters, polyisobutenes, polyisoprenes, ethylene/ethyl acrylate copolymers, polyamides, polycarbonates, polyesters, polyacrylonitriles, polymethyl methacrylates, polyurethanes and mixtures thereof.

These materials are heat-resistant and may be infused with perfume.

It is more preferred for the polymeric material to be an ethylene/vinyl acetate copolymer. A perfumed composition with a particulate carrier, containing an ethylene/vinyl acetate copolymer, releases a virtually constant quantity of perfume on each use when exposed to heat.

It is moreover preferred for the quantity of perfume in the perfumed composition to amount to up to 40 wt. %, preferably to between 5 and 40 wt. %.

In one embodiment of the invention, the wax contains one or more ingredients selected from a group consisting of N,N′-ethylene bis-fatty acid amides, quaternary ammonium compounds, glycerol esters and mixtures thereof. Waxes with these ingredients exhibit a sufficiently high melting point and a sufficiently high abrasion resistance and do not completely disappear from the surface of the release device after just one use cycle.

It is preferred for the quaternary ammonium compound to be selected from the group consisting of monoalk(en)yl trimethyl ammonium compounds, dialk(en)yl dimethyl ammonium compounds, quaternized mono-, di- and/or triesters of fatty acids with alkanolamines, N,N-dipolyethoxyethyl N-ethyl N-alk(en)yl ammonium compounds, N-methyl N-bis-(alk(en)ylamidoethyl)-2-hydroxyethyl ammonium compounds and mixtures thereof. These quaternary ammonium compounds may additionally impart softness and/or anti-static properties to the textiles treated with the system.

In an alternative embodiment, the perfumed composition comprises a water-soluble particulate carrier, a water-soluble polymer and a perfume.

In one preferred embodiment of the invention, the release device comprises a closable orifice for filling the cavity. After repeated use in a dryer the used, formerly perfumed composition may be removed via the closable orifice and new perfumed composition can be introduced.

The invention will be explained in greater detail below, inter alia with reference to examples.

The present invention provides a system for repeated use in a dryer, which comprises a display showing the end of its service life (“end-of-life” indicator).

The system for use in a dryer contains a perfumed composition, a release device and a wax.

The perfumed composition contains a particulate carrier and a perfume.

In one preferred exemplary embodiment, the particulate carrier is spherical or approximately spherical. The particles may however also be lenticular, cylindrical or exhibit other shapes. It is also possible to introduce particles of different shapes into the release device, such that for example spherical and lenticular particles are to be found in the release device.

The particulate carrier contains at least one polymeric material, wherein the polymeric carrier material has a melting or softening point of between 80 and 100° C. and preferably of between 85 and 90° C.

The polymeric carrier material may for example comprise a substance from the group of ethylene/vinyl acetate copolymers, low or high density polyethylenes (LDPE, HDPE) or mixtures thereof, polypropylene, a polyethylene/polypropylene copolymer, polyether/polyamide block copolymer, styrene/butadiene (block) copolymer, styrene/isoprene (block) copolymer, styrene/ethylene/butylene copolymer, acrylonitrile/butadiene/styrene copolymer, acrylonitrile/butadiene copolymer, polyetherester, polyisobutene, polyisoprene, ethylene/ethyl acrylate copolymer, polyamide, polycarbonate, polyester, polyacrylonitrile, polymethyl methacrylate, polyurethane or a polyvinyl alcohol.

In one preferred embodiment, the particulate carriers contain at least 30 wt. % and preferably at least 70 wt. % of ethylene/vinyl acetate copolymer. The particulate carrier is more preferably produced completely from ethylene/vinyl acetate copolymer.

When using an ethylene/vinyl acetate copolymer as the polymeric material in the particulate carrier, it is preferred for the copolymer to contain less than 20 wt. % of vinyl acetate relative to the total weight of the copolymer. The content of vinyl acetate relative to the total weight of the copolymer is preferably between 15 and 20 wt. %. Excessive quantities of vinyl acetate in the copolymer lead to a severe reduction in the melting or softening point. Quantities of vinyl acetate relative to the total weight of the copolymer of below 15 wt. % often lead to insufficient perfume being absorbed by the particulate carrier.

In one preferred embodiment, the particles have an average diameter of 0.5 to 20 mm, preferably of 1 to 10 mm and in particular of 3 to 6 mm

Suitable ethylene/vinyl acetate copolymers can for example be obtained under the name Elvax® 560 from DuPont.

A further essential component of the perfumed composition is the perfume. A perfume contains individual odorant compounds, such as for example synthetic products of the ester, ether, aldehyde, ketone, alcohol and hydrocarbon type. Preferably, however, mixtures of various odorant compounds are used which together produce an attractive scent note. Such perfume oils may also contain natural odorant mixtures, as are obtainable from plant sources.

The proportion by weight of perfume in the perfumed composition amounts for example to 5 to 40 wt. % and preferably to 10 to 20 wt. %, in each case relative to the total weight of a particle of the perfumed composition.

The perfumed composition may optionally contain further ingredients. To improve the esthetic impression of the perfumed composition, it may be dyed with a suitable dye. Preferred dyes, the selection of which will cause a person skilled in the art no difficulty, have elevated storage stability and are insensitive to the other ingredients and to light and have no marked substantivity relative to textile fibers, so as not to dye the latter.

To produce the perfumed composition, the particulate carriers and the perfume, and, if present, dye, are mixed. To accelerate the time taken for perfume absorption by the particulate carrier, mixing of the ingredients may take place at elevated temperature, preferably between 35 and 50° C.

In an alternative embodiment, the perfumed composition contains a water-soluble particulate carrier, a water-soluble polymer and a perfume, wherein the water-soluble, particulate carrier at least in part comprises an envelope of the water-soluble polymer and the perfume.

In addition to the perfumed composition, the system also comprises a release device. This release device comprises in the interior thereof a cavity formed by one or more walls for accommodating the perfumed composition. The release device is preferably spherical and thus comprises just one wall. The release device may alternatively also have another shape and for example be oval or cylindrical. In the case of a cylindrical embodiment, the release device comprises a plurality of walls, namely two opposing base walls and one side wall.

One wall of the release device preferably comprises a closable orifice for filling the cavity with the perfumed composition. After use in the dryer, the used composition is removed via the closable orifice. The wall or walls comprise perforations. These may be distributed regularly or indeed irregularly in the wall or walls. It is preferred for the diameter of the wall perforations to correspond at most to half of the particle diameter of the water-soluble carrier.

The release device is formed from a heat-resistant material. For example the release device is made from a thermoplastic polymer such as polyvinyl chloride (PVC), high or low density polyethylene (HDPE or LDPE), polyethylene terephthalate (PET), polypropylene (PP), polystyrene or mixtures thereof To reduce noise generation when using the system in the dryer, it may be preferred for the release device to be formed from a resilient, heat-resistant material. Suitable resilient materials include silicones, for example. It may additionally be advantageous in terms of noise generation for the release device to comprise a plurality of outwardly protruding portions/knobs on the outer surface.

The closable orifice is for example a screw cap, a stopper, a slider or a lockable flap.

The release device is preferably transparent or translucent, such that a user may simply identify the amount of perfumed composition in the release device and the nature of the perfumed composition.

On its outer surface, the release device comprises an indentation which is at least in part filled with a wax. The wax preferably has a melting point in the range from 80 to 110° C.

The wax preferably contains one or more ingredients selected from a group consisting of N,N′-ethylene bis-fatty acid amides, quaternary ammonium compounds, glycerol esters and mixtures thereof.

Examples of suitable N,N′-ethylene bisfatty acid amides include N,N′-ethylene bis-stearamide and/or N,N′-ethylene bis-palmitamide. A mixture of N,N′-ethylene bis-stearamide and N,N′-ethylene bis-palmitamide can for example be obtained under the name Acrawax C from Lonza.

Suitable quaternary ammonium compounds comprise compounds such as monoalk(en)yl trimethyl ammonium compounds, dialk(en)yl dimethyl ammonium compounds, quaternized mono-, di- and/or triesters of fatty acids with alkanolamines, N,N-dipolyethoxyethyl N-ethyl N-alk(en)yl ammonium compounds, N-methyl N-bis-(alk(en)ylamidoethyl)-2-hydroxyethyl ammonium compounds and mixtures thereof.

Suitable examples of quaternary ammonium compounds are shown for example in formulae (I) and (II):

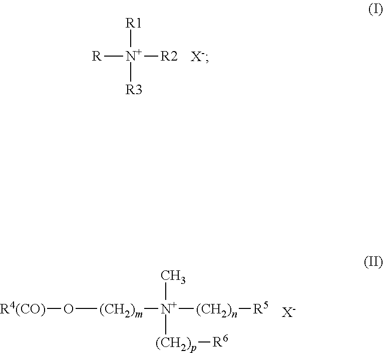

wherein, in (I), R denotes an acyclic alkyl residue with 12 to 24 carbon atoms, R¹ denotes a saturated C₁-C₄ alkyl or hydroxyalkyl residue, R² and R³ are either identical to R or R¹ or denote an aromatic residue. X⁻ denotes alternatively a halide, methosulfate, methophosphate or phosphate ion and mixtures of these. Examples of cationic compounds of the formula (I) are monotallow trimethyl ammonium chloride, monostearyl trimethyl ammonium chloride, didecyl dimethyl ammonium chloride, ditallow dimethyl ammonium chloride or dihexadecyl ammonium chloride.

Compounds of formulae (II), (III) and (IV) are “esterquats”. Esterquats are distinguished by excellent biodegradability. In formula (II), R⁴ denotes an aliphatic alk(en)yl residue with 12 to 22 carbon atoms with 0, 1, 2 or 3 double bonds and/or optionally with substituents; R⁵ denotes H, OH, or O(CO)R⁷; R⁶, independently of R⁵, denotes H, OH, or O(CO)R⁸, wherein R⁷ and R⁸ mutually independently in each case denote an aliphatic alk(en)yl residue with 12 to 22 carbon atoms with 0, 1, 2 or 3 double bonds; m, n and p may in each case mutually independently have the value 1, 2 or 3. X⁻ may be alternatively a halide, methosulfate, methophosphate or phosphate ion and mixtures of these anions. Compounds are preferred in which R⁵ represents the group O(CO)R⁷. More preferred compounds are those in which R⁵ represents the group O(CO)R⁷ and R⁴ and R⁷ are alk(en)yl residues with 16 to 18 carbon atoms. More preferred compounds are those in which R⁶ additionally denotes OH. Examples of compounds of formula (II) are methyl N-(2-hydroxyethyl) N,N-di(tallowacyloxyethyl) ammonium methosulfate, bis-(palmitoyloxyethyl) hydroxyethyl methyl ammonium methosulfate or methyl N,N-bis-(stearoyloxyethyl) N-(2-hydroxyethyl) ammonium methosulfate.

If quaternized compounds of the formula (II) which comprise unsaturated alkyl chains are used, preferred acyl groups are those whose corresponding fatty acids exhibit an iodine value of between 1 and 100, preferably of between 5 and 80, more preferably of between 10 and 60 and in particular of between 15 and 45 and which have a cis/trans isomer ratio (in wt.%) of greater than 30:70, preferably of greater than 50:50 and in particular of greater than 60:40. Conventional commercial examples are the methyl hydroxyalkyl dialkoyloxyalkyl ammonium methosulfates sold by Stepan under the trade name Stepantex® or the BASF products known under the name of Dehyquart®, the Evonik products known under the name Rewoquat® or the Kao products known under the name Tetranyl®. Further preferred compounds are the diesterquats of formula (III), which are obtainable under the name Rewoquat® W 222 LM or CR 3099.

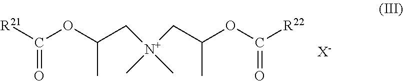

R²¹ and R²² here mutually independently in each case denote an aliphatic residue with 12 to 22 carbon atoms with 0, 1, 2 or 3 double bonds.

Instead of the ester group O(CO)R, in which R denotes a long-chain alk(en)yl residue, softening compounds may be used which comprise the following groups: RO(CO), N(CO)R or RN(CO), wherein of these groups N(CO)R groups are preferred.

Further suitable quaternary ammonium compounds are described by formula (V),

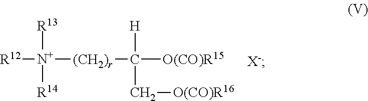

wherein R¹², R¹³ and R¹⁴ mutually independently denote a C₁₋₄ alkyl, alkenyl or hydroxyalkyl group, R¹⁵ and R¹⁶, in each case independently selected, represent a C₈₋₂₈ alkyl group, X⁻ is an anion and r is a number between 0 and 5. A preferred example of a cationic deposition aid according to formula (V) is 2,3-bis[tallowacyloxy]-3-trimethyl ammonium propane chloride.

Further suitable quaternary ammonium compounds N,N-dipolyethoxyethyl N-ethyl N-alk(en)yl ammonium compounds and N-methyl N-bis-(alk(en)ylamidoethyl) 2-hydroxyethyl ammonium compounds.

It may be preferred for the wax to contain one or more glycerol esters, such as for example glycerol monostearate.

More preferably, the wax contains a mixture of at least two of the stated ingredients.

The wax may additionally contain a filler, such as silica. The quantity of filler may amount to between 0.1 and 10 wt. % and preferably amounts to 1 to 5 wt. %.

The wax may also contain a pearlescent agent to increase gloss Examples of suitable pearlescent agents are ethylene glycol mono- and distearate (for example Cutina® AGS from Cognis) and PEG-3 distearate.

To improve the esthetic impression of the wax or to increase the visibility of the wax, it may be dyed with a suitable dye. Preferred dyes, the selection of which will cause a person skilled in the art no difficulty, have elevated storage stability and are insensitive to the other ingredients of the agents and to heat and light and have no marked substantivity relative to textile fibers, so as not to dye the latter.

The wax is introduced into an indentation located on the outer surface, such that the indentation is filled at least in part with a wax. The quantity of wax in the indentation depends on the number of desired applications and the shape and depth of the indentation.

### EXEMPLARY EMBODIMENTS

Table 1 shows the compositions of a perfumed composition PZ1 (all quantities are stated in wt. % of active substance, relative to the total perfumed composition):

TABLE 1

| | PZ1 |
|---|---|
| Elvax Pearls 560 (diameter = 1.5-3 mm) | 85.99 |
| Perfume | 14 |
| Dye (blue) | 0.01 |

Table 2 shows the composition of various waxes (all quantities are stated in wt. % of active substance, relative to the composition).

TABLE 2

| | W1 | W2 | W3 | W4 | W5 |
|---|---|---|---|---|---|
| N,N′-Ethylene bis-stearamide and N,N′- | 50 | 40 | 30 | 25 | 50 |
| ethylene bis-palmitamide | | | | | |
| Glycerol monostearate | 50 | 40 | 20 | — | — |
| Methyl N-(2-hydroxyethyl) N,N- | — | 20 | 50 | 75 | — |
| di(tallowacyloxyethyl) ammonium | | | | | |
| methosulfate | | | | | |
| N-Methyl N-bis-(tallowamidoethyl) 2- | — | — | — | — | 45 |
| hydroxyethyl ammonium methosulfate | | | | | |
| N,N-Dipolyethoxyethyl N-ethyl N- | — | — | — | — | 5 |
| tallow ammonium ethyl sulfate | | | | | |

40 g of the perfumed compositions PZ1 were introduced via an orifice into a release device in the form of a dispensing ball of HDPE with a diameter of 10 cm, whose wall exhibited regularly distributed perforations with a diameter of 200 to 800 μm. The release device was closed by a screw cap. On the outer surface, the release device exhibited an indentation for accommodating a maximum of 5 g of wax.

The indentations of various release devices filled in this way were then each filled with 3.5 to 4 g of waxes W1 to W5. The release devices were each placed into a tumble dryer with damp textiles and subjected to up to 20 dryer cycles. After each cycle the quantity of wax released was determined. After 10 dryer cycles, between 30 and 50% of the waxes W1 to W5 had been released.

By using waxes W2 to W5, an anti-static effect could be identified on the textiles treated therewith over at least 10 dryer cycles.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A system composed of perfumed composition and release device for repeated use in a dryer, wherein the perfumed composition comprises a particulate carrier and a perfume, and the release device comprises, in the interior of the device, a cavity for accommodating the perfumed composition, formed by one or more walls having perforations, the system further characterized in that the release device comprises an indentation on its external surface which is at least in part filled with a wax.

2. The system according to claim 1, characterized in that the carrier comprises a polymeric material.

3. The system according to claim 2, characterized in that the polymeric material of the particulate carrier is selected from the group consisting of ethylene/vinyl acetate copolymers, polyethylenes, polypropylenes, polyethylene/polypropylene copolymers, polyether/polyamide block copolymers, styrene/butadiene (block) copolymers, styrene/isoprene (block) copolymers, styrene/ethylene/butylene copolymers, acrylonitrile/butadiene/styrene copolymers, acrylonitrile/butadiene copolymers, polyetheresters, polyisobutenes, polyisoprenes, ethylene/ethyl acrylate copolymers, polyamides, polycarbonates, polyesters, polyacrylonitriles, polymethyl methacrylates, polyurethanes and mixtures thereof,

4. The system according to claim 3, characterized in that the polymeric material is an ethylene/vinyl acetate copolymer.

5. The system according to claim 1, wherein perfume comprises up to 20 wt. % of the perfumed composition.

6. The system according to claim 1, wherein the wax contains one or more ingredients selected from the group consisting of N,N′-ethylene-bis-fatty acid amides, quaternary ammonium compounds, glycerol esters and mixtures thereof

7. The system according to claim 1, wherein the quaternary ammonium compound is selected from the group consisting of monoalk(en)yl trimethyl ammonium compounds, dialk(en)yl dimethyl ammonium compounds, quaternized mono-, di-and/or triesters of fatty acids with alkanolamines, N,N-dipolyethoxyethyl N-ethyl N-alk(en)yl ammonium compounds, N-methyl N-bis-(alk(en)ylamidoethyl)-2-hydroxyethyl ammonium compounds and mixtures thereof

8. The system according to claim 1, characterized in that the perfumed composition comprises a water-soluble particulate carrier, a water-soluble polymer and a perfume.

9. The system according to claim 1, wherein the diameter of the wall perforations corresponds to at most half of the particle diameter of the particulate carrier.

10. The system according to claim 1, wherein the release device comprises a closable orifice for filling the cavity.
